(19) United States
(12) Patent Application Publication
(10) Pub. No.: US 2017/0323395 A1
(43) Pub. Date: Nov. 9, 2017

(54) SYSTEM AND METHOD FOR CREATING HISTORICAL RECORDS BASED ON UNSTRUCTURED ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/596,489

(22) Filed: May 16, 2017

Related U.S. Application Data
(63) Continuation-in-part of application No. 15/361,934, filed on Nov. 28, 2016.
(60) Provisional application No. 62/337,891, filed on May 18, 2016.
(60) Provisional application No. 62/260,553, filed on Nov. 29, 2015.
(60) Provisional application No. 62/261,355, filed on Dec. 1, 2015.

(51) Int. Cl. G06Q 40/00; G06F 17/30

(52) U.S. Cl. CPC G06Q 40/123; G06F 17/30011

(57) ABSTRACT

A system and method for generating recommendations based on unstructured electronic documents. The method includes analyzing a plurality of electronic documents to determine at least one transaction parameter for each electronic document, wherein at least one of the analyzed electronic documents includes at least partially unstructured data; creating a template for each analyzed electronic document, wherein each template is a structured dataset including the determined at least one transaction parameter for the respective electronic document; identifying at least one commonality among the created templates; and creating, based on the identified commonalities, a historical record, the historical record characterizing at least a portion of the transaction parameters of at least one group of the electronic documents.

### CROSS-REFERENCE TO RELATED APPLICATIONS

This application claims the benefit of U.S. Provisional Application No. 62/337,891 filed on May 18, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to profiling enterprises, and more particularly to profiling enterprises based on electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

As businesses increasingly rely on technology to manage data related to operations such as invoice and purchase order data, suitable systems for properly managing and collecting data have become crucial to success. Particularly for large businesses, the amount of data utilized daily by businesses can be overwhelming. Accordingly, manual review and collection of such data is impractical, at best.

Additionally, business expenses are frequently higher than necessary due to inefficient selections of, e.g., suppliers of goods and services, types of goods purchased (e.g., selecting more expensive but equally effective goods), and the like. Businesses seeking to reduce unnecessary expenses often hire professionals to identify expenses that can be reduced or eliminated. However, such professionals must manually analyze both company expense records and alternative expense options to identify areas for improvement.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

Because existing solutions face challenges in accurately preparing information in electronic documents for subsequent use, automated solutions for reducing expenses face challenges in accurately identifying information in the electronic documents needed to generate recommendations for optimizing expenses.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for creating historical records based on at least partially unstructured electronic documents. The method comprises: analyzing a plurality of electronic documents to determine at least one transaction parameter for each electronic document, wherein at least one of the analyzed electronic documents includes at least partially unstructured data; creating a template for each analyzed electronic document, wherein each template is a structured dataset including the determined at least one transaction parameter for the respective electronic document; identifying at least one commonality among the created templates; and creating, based on the identified commonalities, a historical record, the historical record characterizing at least a portion of the transaction parameters of at least one group of the electronic documents.

Certain embodiments disclosed herein also include a non-transitory computer readable medium having stored thereon instructions for causing a processing circuitry to perform a process, the process comprising: analyzing a plurality of electronic documents to determine at least one transaction parameter for each electronic document, wherein at least one of the analyzed electronic documents includes at least partially unstructured data; creating a template for each analyzed electronic document, wherein each template is a structured dataset including the determined at least one transaction parameter for the respective electronic document; identifying at least one commonality among the created templates; and creating, based on the identified commonalities, a historical record, the historical record characterizing at least a portion of the transaction parameters of at least one group of the electronic documents.

Certain embodiments disclosed herein also include a system for creating historical records based on at least partially unstructured electronic documents. The system comprises: a processing circuitry; and a memory, the memory containing instructions that, when executed by the processing circuitry, configure the system to: analyze a plurality of electronic documents to determine at least one transaction parameter for each electronic document, wherein at least one of the analyzed electronic documents includes at least partially unstructured data; create a template for each analyzed electronic document, wherein each template is a structured dataset including the determined at least one transaction parameter for the respective electronic document; identify at least one commonality among the created templates; and create, based on the identified commonalities, a historical record, the historical record characterizing at least a portion of the transaction parameters of at least one group of the electronic documents.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a record manager according to an embodiment.

FIG. 3 is a flowchart illustrating a method for creating historical records based on at least partially unstructured electronic documents according to an embodiment.

FIG. 4 is a flowchart illustrating a method for creating a dataset based on at least one electronic document according to an embodiment.

FIG. 5 is a flowchart illustrating a method for generating recommendations based on enterprise transaction historical records according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for creating historical records based on electronic documents. In an embodiment, at least one dataset is created based on electronic documents indicating transaction information related to an enterprise. A template of transaction attributes is created based on each electronic document dataset. The templates are structured datasets created based on at least partially unstructured data generated via machine imaging of the electronic documents.

Based on the created templates, an enterprise transaction historical record is created. The transaction historical record indicates the transaction information related to a plurality of transactions involving the enterprise (e.g., where the enterprise is a buyer) as indicated in the electronic documents. The created transaction historical record is compared to a plurality of existing transaction historical records associated with other enterprises, and analytics are generated based on the comparison. Based on the analytics, at least one recommendation may be generated. The at least one recommendation may indicate at least one recommended action for reducing transaction costs.

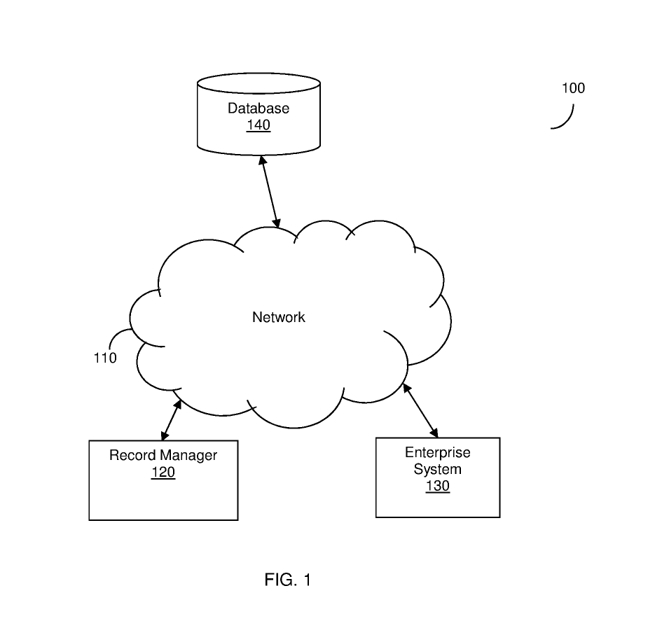

FIG. 1 shows an example network diagram 100 utilized to describe the various disclosed embodiments. In the example network diagram 100, a record manager 120, an enterprise system 130, and a database 140, are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to transactions involving the enterprise or representatives of the enterprise as well as data related to the enterprise itself. The enterprise may be, but is not limited to, an enterprise such as a business whose employees may purchase goods and services pursuant to their roles and responsibilities. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, etc.). Each electronic document may show, e.g., an invoice, a tax receipt, a purchase number record, and the like. Data included in at least some of the electronic documents is at least partially unstructured such that the data may be structured, semi-structured, unstructured, or a combination thereof. The structured or semi-structured data may be in a format that is not recognized by the record manager 120 and, therefore, may be treated as unstructured data.

Each electronic document may be related to a transaction involving the enterprise. Consequently, the electronic documents may indicate at least expenses incurred by the enterprise during the transaction and other information related thereto. As a non-limiting example, an electronic document may indicate a type of good or service purchased (e.g., a hotel stay), a time of the transaction, a price per unit, a quantity, a buyer, a supplier (e.g., a seller or a manufacturer), supplier information (e.g., name, merchant registration number, etc.), combinations thereof, and the like.

The database 140 stores enterprise transaction historical records associated with a plurality of enterprises. The transaction historical record of each enterprise includes information related to a plurality of transactions involving the enterprise, and may be utilized for generating recommendations. The database 140 may also stores recommendations generated by the record manager 120.

In an embodiment, the record manager 120 is configured to create templates based on transaction parameters identified using machine vision on at least partially unstructured electronic documents indicating information related to transactions involving an enterprise. In a further embodiment, the record manager 120 may be configured to retrieve the electronic documents from, e.g., the enterprise system 130. Alternatively or collectively, electronic documents may be received from client devices (not shown) utilized by employees or other representatives of the enterprise. Based on the created templates, the record manager 120 is configured to create an enterprise transaction historical record that represents a plurality of transactions involving the enterprise (e.g., transactions in which the enterprise incurred expenses).

Each template is a structured dataset including the identified transaction parameters for a transaction. The transaction parameters indicate information related to the transaction that are indicated in the electronic document such as, but not limited to, a type of good or service purchased (e.g., a hotel stay), a time of the transaction, a price per unit, a quantity, a buyer, a supplier (e.g., a seller or a manufacturer), supplier information (e.g., name, merchant registration number, etc.), and the like.

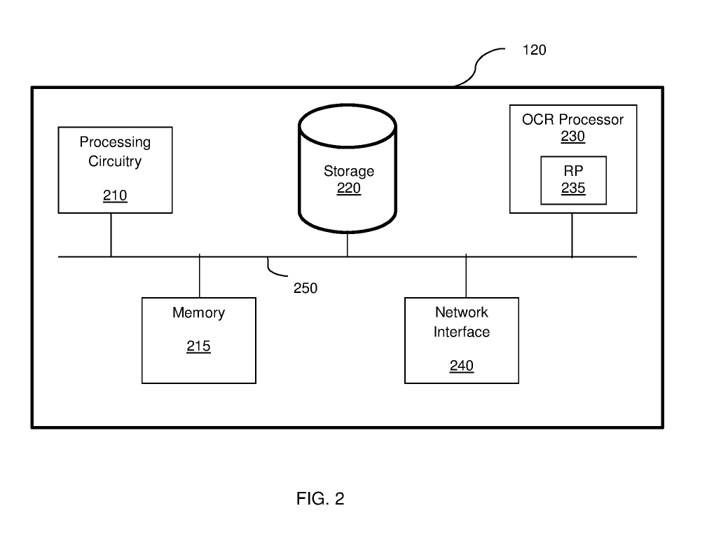

In an embodiment, the record manager 120 is configured to create datasets based on at least partially unstructured electronic documents including data at least partially lacking a known structure (e.g., unstructured data, semi-structured data, or structured data having an unknown structure). To this end, in a further embodiment, the record manager 120 may be further configured to utilize optical character recognition (OCR) or other image processing to determine data in the electronic document. The record manager 120 may therefore include or be communicatively connected to a recognition processor (e.g., the recognition processor 235, FIG. 2). Based on the datasets, the record manager 120 is configured to create the templates.

In another embodiment, the record manager 120 may be further configured to validate each electronic document based on its respective template. The validation may include, but is not limited to, determining whether each electronic document is complete and accurate.

Each electronic document may be determined to be complete if, for example, one or more predetermined reporting requirements is met (e.g., for a purchase, relevant requirements may include types of goods or services purchased, total price, quantity, supplier, etc.).

Each electronic document may be determined to be accurate based on data stored in at least one external source. The at least one electronic source may include, but is not limited to, one or more web sources or other data sources (not shown). As a non-limiting example, a merchant server of a merchant who was the seller in a transaction may be queried for metadata related to the electronic document associated with the transaction, and the metadata obtained via the query may be compared to data of the template for the electronic document. For example, the metadata obtained via the query may include a price of the transaction, a transaction identifier, and the like, which may be compared to data in corresponding fields of the template created for the transaction.

In an embodiment, the record manager 120 is configured to analyze the created templates to identify commonalities among the transactions with respect to the transaction parameters. The commonalities may be transaction parameters shared by two or more transactions. The commonalities may be identified, e.g., with respect to fields of the templates such that the same or similar fields including transaction parameters having common values may be identified as commonalities. As a non-limiting example, commonalities among transactions may indicate that 2,000 invoices (and, accordingly, 2,000 corresponding transactions) involved hotel stays in Berlin, Germany.

In an embodiment, based on the identified commonalities and the transaction parameters indicated in the created templates, the record manager 120 is configured to create an enterprise transaction historical record for the enterprise. The transaction historical record characterizes at least a portion of transaction parameters of at least one group of transactions and, consequently, of at least one group of corresponding electronic documents. To this end, each historical record may include, for each group of transactions, a set of transaction group parameters. Each transaction group parameter may be a value indicating information related to the group of transactions such as, but not limited to, an average of transaction parameters of the transactions (e.g., an average cost determined based on a cost of each transaction in the group), a number of transactions in the group, a commonality shared by transactions in the group, and the like. The transaction group parameters may be determined based on the commonalities and the transaction parameters of each group of transactions.

As a non-limiting example, the transaction historical record may illustrate that 2,000 transactions involving hotel stays in Berlin, Germany, had an average cost of $100 USD, and each transaction involved a stay in one of two hotels. The transaction historical record may further include information related to sub-groups of transactions. As a non-limiting example, the transaction historical record may indicate that, of the 2,000 transactions involving hotel stays in Berlin, Germany, 400 of the transactions involved a stay in a first hotel with an average cost of $50 USD, and 1,600 of the transactions involved a stay in a second hotel with an average cost of $112.50 USD.

In some embodiments, the transaction historical record may not be based on insignificant transactions. A transaction may be insignificant if the transaction does not reflect a trend in transactions, for example if the transaction has an expense below a threshold value (e.g., below $10 USD total), if the transaction is for an anomalous or otherwise non-recurring purchase of a good or service (e.g., if the transaction is for the only purchase of a vending machine made by the enterprise), combinations thereof, and the like.

In an embodiment, the record manager 120 is configured to compare the created transaction historical record to a plurality of existing transaction historical records, where each existing transaction historical record is associated with another enterprise. In a further embodiment, based on the comparison, the record manager 120 is configured to select at least one of the existing transaction historical records that is similar to the created transaction historical record. In yet a further embodiment, each selected existing transaction historical record may include at least a threshold number of transactions sharing commonalities with corresponding transactions of the created transaction historical record. As a non-limiting example, at least three transactions of each enterprise sharing both a location of Tokyo, Japan, and a time of April 2016. As another non-limiting example, at least four transactions of each enterprise involving the same supplier. In another embodiment, two transaction historical records may be similar if the enterprises associated with the transaction historical records are similar. As a non-limiting example, if the enterprises are registered for business in the same country.

Alternatively or collectively, the selection may include generating a similarity score for the created transaction historical record with respect to each compared existing transaction historical record, and only existing transaction historical records having a similarity score with respect to the created transaction historical record. The similarity scores may be generated based on shared commonalities in the historical records (e.g., registration in same country, similar suppliers, locations of transactions, etc.), and may further be determined based on numbers of transactions sharing the commonalities. The similarity scores may be computed based on predetermined weights for different types of commonalities, numbers of commonalities, or a combination thereof.

In an embodiment, the record manager 120 is configured to generate at least one analytic based on the created transaction historical record and each similar existing transaction historical record. The analytics may indicate, for example, differences in the transaction historical records. As a non-limiting example, the analytics may indicate that prices of hotel stays in a particular town bought from a first hotel or group of hotels (e.g., a hotel chain) is on average higher than prices of hotel stays in the same town bought from other hotels or groups of hotels (e.g., other hotel chains).

In an embodiment, based on the analytics, the record manager 120 is configured to identify at least one suboptimal analytic of the enterprise. In an example implementation, each suboptimal analytic indicates an expense (e.g., total, average, etc.) of a group of transactions sharing at least one commonality related to the enterprise that is higher than expenses of groups of transactions sharing the at least one commonality that are related to other enterprises. The expense may be before rebates or refunds, or after (e.g., the total cost of the transaction minus applicable refunds, such as after a value-added tax is refunded). As a non-limiting example, the suboptimal analytic may include that the enterprise pays a total of $20,000 USD more than other enterprises for hotels in New York City in 2012.

In an embodiment, based on the at least one suboptimal analytic, the record manager 120 is configured to determine at least one cause of the suboptimal analytic. Each cause may be, for example, use of a particular supplier, purchase of a particular product or brand of products, failure to secure the full amount the enterprise is entitled to for a refund (e.g., due to an issue in a reverse charge mechanism used by the enterprise), and the like.

In an embodiment, based on the at least one suboptimal analytic, the record manager 120 is configured to generate at least one recommendation for optimizing the at least one suboptimal analytic. The at least one recommendation may indicate, but is not limited to, an optimal supplier, an optimal service, an optimal product, correcting a refund mechanism, a combination thereof, and the like. In a further embodiment, the at least one recommendation may be generated based further on the at least one suboptimal analytic. In another embodiment, the recommendations may be stored in a database for subsequent use. In yet another embodiment, the recommendations may be sent to, e.g., a client device or enterprise system associated with the enterprise.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the record manager 120 according to an embodiment. The record manager 120 includes a processing circuitry 210 coupled to a memory 215, a storage 220, and a network interface 240. In an embodiment, the record manager 120 may include an optical character recognition (OCR) processor 230. In another embodiment, the components of the record manager 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to create historical records based on at least partially unstructured electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in at least partially unstructured data sets. Specifically, in an embodiment, the OCR processor 230 is configured to identify at least characters in the unstructured data. The identified characters may be utilized to create a dataset including data required for analyzing transactions and generating recommendations based thereon.

The network interface 240 allows the record manager 120 to communicate with the enterprise system 130, the database 140, or both, for purposes such as, for example, obtaining electronic documents, storing transaction historical records, obtaining transaction historical records, sending recommendations, and the like.

It should be understood that the embodiments described herein are not limited to the specific architecture illustrated in FIG. 2, and other architectures may be equally used without departing from the scope of the disclosed embodiments.

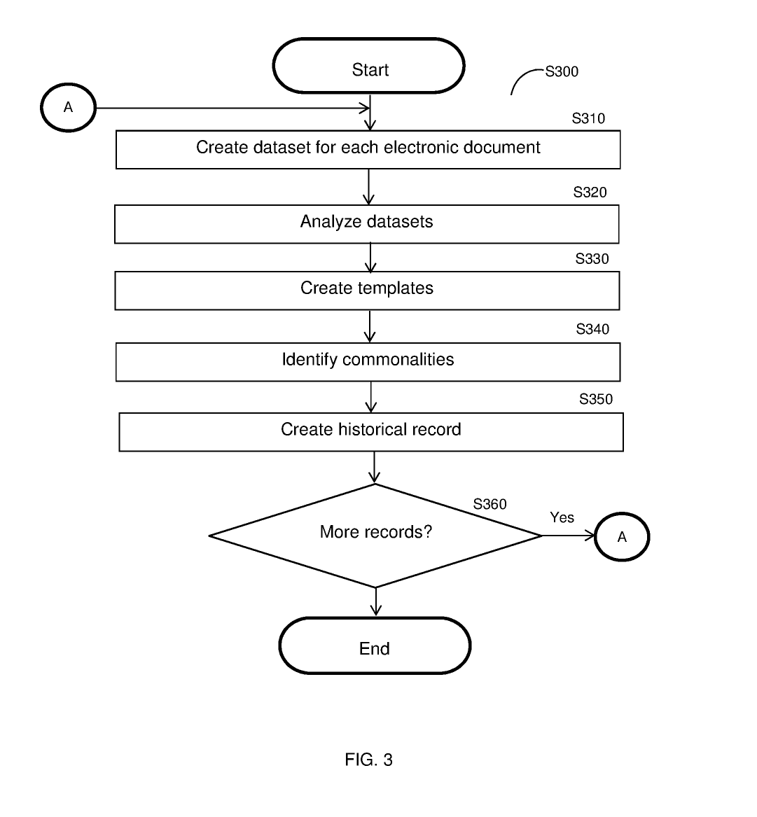

FIG. 3 is an example flowchart 300 illustrating a method for creating historical records based on electronic documents according to an embodiment. In an embodiment, the method is performed by the record manager 120. In another embodiment, the historical records are enterprise transaction historical records created with respect to a first enterprise based on transactions involving the enterprise. For example, the recommendations may be provided with respect to an enterprise (e.g., a company) based on transactions in which the enterprise was the seller.

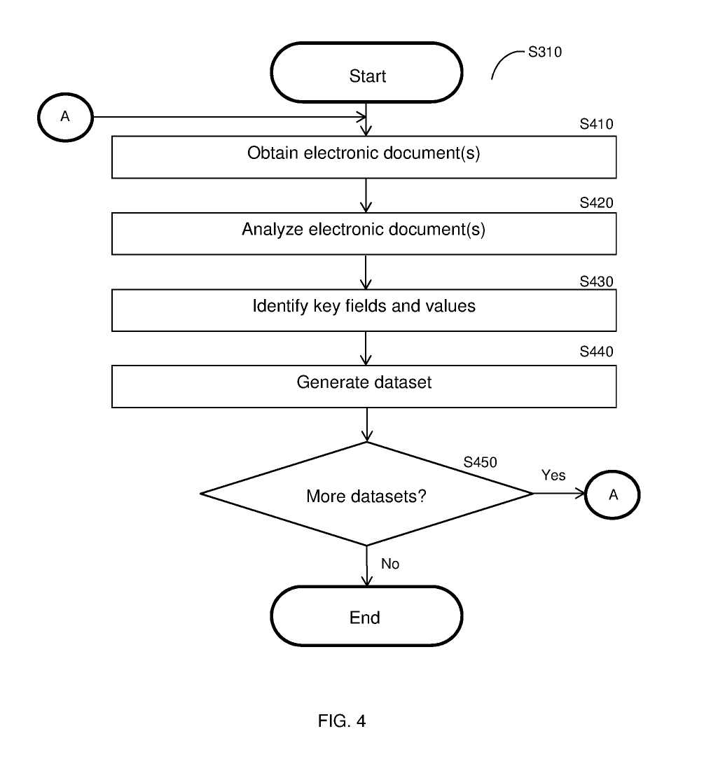

At S310, a dataset is created for each electronic document including information related to a transaction. Each electronic document indicates at least partially unstructured data of a transaction involving the enterprise and may include, but is not limited to, unstructured data, semi-structured data, structured data with structure that is unanticipated or unannounced, or a combination thereof. In an embodiment, S310 may further include analyzing each electronic document using optical character recognition (OCR) to determine data in the electronic document, identifying key fields in the data, identifying values in the data, or a combination thereof. Creating datasets based on at least partially unstructured electronic documents is described further herein below with respect to FIG. 4.

At S320, the datasets are analyzed. In an embodiment, analyzing each dataset may include, but is not limited to, determining transaction parameters such as, but not limited to, at least one enterprise identifier (e.g., a consumer enterprise identifier, a merchant enterprise identifier, or both), information related to the transaction (e.g., a date, a time, a price, a type of good or service sold, etc.), or both. In a further embodiment, analyzing each dataset may also include identifying the transaction based on the dataset.

At S330, a template is created based on each analyzed dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, the created templates are analyzed to identify commonalities among the templates. In an embodiment, the commonalities are identified based on data of the templates with respect to fields of the templates. Each commonality may include at least one transaction parameter that is common to both of two compared templates. As a non-limiting example, a commonality may be a transaction parameter indicating a purchase of “ABC Company” office supplies as indicated in a “supplier” or “brand” field of each of the compared templates. As another non-limiting example, a commonality may include transaction parameters indicating a location “New York City, New York” and a type of service purchased “hotel stay” as indicated in a “location” and a “good/service” field, respectively, of each of the compared templates.

At S350, based on the identified commonalities and other transaction parameters in the created templates, a transaction historical record is created for the first enterprise. The transaction historical record characterizes at least a portion of transaction parameters of at least one group of transactions and, consequently, of at least one group of corresponding electronic documents. The transaction historical record includes transaction group parameters indicating information related to groups of transactions sharing commonalities. In an example implementation, the transaction historical record includes transaction group parameters indicating at least the commonalities for each group of transactions, a number of transactions in each group of transactions, an average expense of each group of transactions, or a combination thereof. To this end, in an embodiment, S350 may include determining the transaction group parameters for each group of transactions based on the commonalities of the group and the transaction parameters of transactions in the group. In another embodiment, S350 may further include storing the created transaction historical record in a database.

At S360, it is determined if additional enterprise transaction historical records are to be created and, if so, execution continues with S310; otherwise, execution terminates.

Creating and storing a plurality of transaction historical records for different enterprises allows for creation of a database of transaction historical records. The transaction historical records in the database may be compared to identify similarities and differences, thereby allowing for generating recommendations for optimizing transaction parameters. Further, use of the templates allows for efficient creation of the transaction historical records when the electronic documents utilized to create the transaction historical records are at least partially unstructured.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

At S450, it is determined if structured datasets for additional transactions are to be created and, if so, execution continues with S410; otherwise, execution terminates.

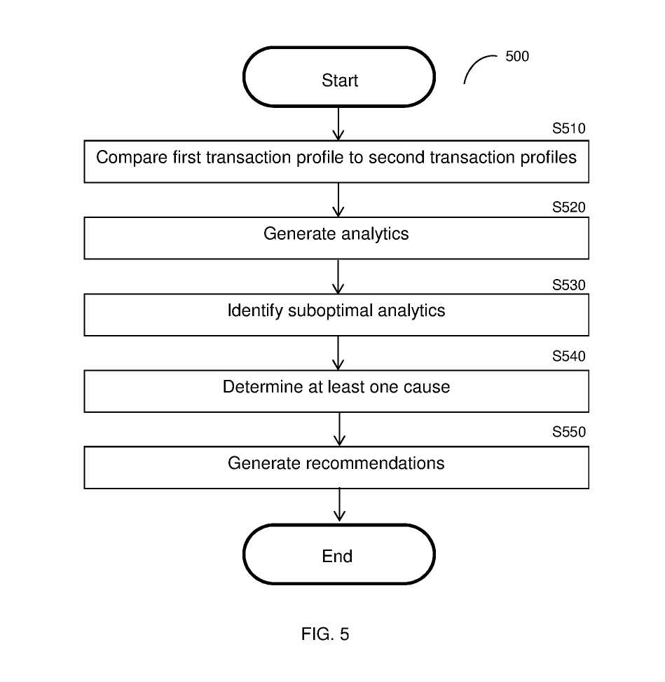

FIG. 5 is an example flowchart 500 illustrating a method for generating recommendations based on enterprise transaction historical records according to an embodiment. In an embodiment, the method may be performed by the record manager 120.

At S510, a first transaction historical record of a first enterprise is compared to a plurality of second transaction historical records associated with a plurality of second enterprises to select at least one similar transaction historical record, where each similar transaction historical record is associated with one of the plurality of second enterprises. In an embodiment, each selected transaction historical record has at least a threshold number of transactions sharing commonalities with transactions of the created transaction historical record of the first enterprise. In another embodiment, S510 may include retrieving, from a storage, the plurality of second transaction historical records.

At S520, based on the comparison, at least one analytic is generated for the first transaction historical record with respect to each selected second transaction historical record. The analytics may indicate, for example, similarities or differences in costs of transactions (e.g., a difference in average costs of transactions of the compared transaction historical records). The difference may further be positive or negative, where a positive difference indicates, e.g., that average costs of transactions of the first transaction historical record are greater than the average cost of transactions of the second transaction historical record. In an embodiment, the analytics may be further generated with respect to commonalities shared by the first transaction historical record with each second transaction historical record.

At S530, at least one suboptimal analytic is identified. The at least one suboptimal analytic may indicate an inefficiency in, e.g., costs, for transactions involving the first enterprise as compared to at least one of the second enterprises. The at least one suboptimal analytic may be determined based on a direction (i.e., positive or negative) of difference in costs, a degree of difference in costs, a combination thereof, and the like.

At optional S540, based on the identified at least one suboptimal analytic, at least one cause may be determined. The at least one cause may include, but is not limited to, use of a particular supplier, purchase of a particular brand of goods, purchase of a particular quality of goods, purchase of a particular type of goods, failure to secure the full value of a refund, a combination thereof, and the like.

At S550, at least one recommendation for optimizing transactions is generated. The at least one recommendation may indicate optimal transaction parameters for, e.g., decreasing costs of transactions. As a non-limiting example, the at least one recommendation may indicate an optimal supplier, where the optimal supplier is indicated as the supplier for a second entity in the at least one suboptimal analytic. In an embodiment, the at least one recommendation may be generated based further on the determined at least one cause.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for creating historical records based on at least partially unstructured electronic documents, comprising:
analyzing a plurality of electronic documents to determine at least one transaction parameter for each electronic document, wherein at least one of the analyzed electronic documents includes at least partially unstructured data;
creating a template for each analyzed electronic document, wherein each template is a structured dataset including the determined at least one transaction parameter for the respective electronic document;
identifying at least one commonality among the created templates; and
creating, based on the identified commonalities, a historical record, the historical record characterizing at least a portion of the transaction parameters of at least one group of the electronic documents.

2. The method of claim 1, wherein determining the at least one transaction parameter for each electronic document further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 1, wherein each commonality is identified with respect to a field of at least two of the created templates.

5. The method of claim 1, wherein each electronic document indicates a transaction involving an enterprise, wherein the created historical record is an enterprise transaction historical record characterizing transactions involving the enterprise.

6. The method of claim 1, wherein the created historical record is a first historical record for a first enterprise, further comprising:
comparing the first historical record to a plurality of second historical records, wherein each second historical record is associated with a distinct second enterprise; and
generating, based on the comparison, at least one analytic of the first historical record with respect to each second historical record; and
generating, based on the analytics, at least one recommendation.

7. The method of claim 6, further comprising:
identifying at least one suboptimal analytic of the generated analytics, wherein the at least one recommendation is for optimizing the at least one suboptimal analytic.

8. The method of claim 7, further comprising:
determining at least one cause of the identified at least one suboptimal analytic.

9. The method of claim 6, wherein the at least one recommendation indicates at least one optimal transaction parameter.

10. A non-transitory computer readable medium having stored thereon instructions for causing a processing circuitry to perform a process, the process comprising:
analyzing a plurality of electronic documents to determine at least one transaction parameter for each electronic document, wherein at least one of the analyzed electronic documents includes at least partially unstructured data;
creating a template for each analyzed electronic document, wherein each template is a structured dataset including the determined at least one transaction parameter for the respective electronic document;
identifying at least one commonality among the created templates; and
creating, based on the identified commonalities, a historical record, the historical record characterizing at least a portion of the transaction parameters of at least one group of the electronic documents.

11. A system for validating a transaction represented by an electronic document, comprising:
a processing circuitry; and
a memory, the memory containing instructions that, when executed by the processing circuitry, configure the system to:
analyze a plurality of electronic documents to determine at least one transaction parameter for each electronic document, wherein at least one of the analyzed electronic documents includes at least partially unstructured data;
create a template for each analyzed electronic document, wherein each template is a structured dataset including the determined at least one transaction parameter for the respective electronic document;
identify at least one commonality among the created templates; and
create, based on the identified commonalities, a historical record, the historical record characterizing at least a portion of the transaction parameters of at least one group of the electronic documents.

12. The system of claim 11, wherein determining the at least one transaction parameter for each electronic document further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

13. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

14. The system of claim 11, wherein each commonality is identified with respect to a field of at least two of the created templates.

15. The system of claim 11, wherein each electronic document indicates a transaction involving an enterprise, wherein the created historical record is an enterprise transaction historical record characterizing transactions involving the enterprise.

16. The system of claim 11, wherein the system is further configured to:
compare the first historical record to a plurality of second historical records, wherein each second historical record is associated with a distinct second enterprise; and
generate, based on the comparison, at least one analytic of the first historical record with respect to each second historical record; and
generate, based on the analytics, at least one recommendation.

17. The system of claim 16, wherein the system is further configured to:
identify at least one suboptimal analytic of the generated analytics, wherein the at least one recommendation is for optimizing the at least one suboptimal analytic.

18. The system of claim 17, wherein the system is further configured to:
determine at least one cause of the identified at least one suboptimal analytic.

19. The system of claim 16, wherein the at least one recommendation indicates at least one optimal transaction parameter.

20. The system of claim 11, further comprising:
an optical character recognition processor, wherein the system is further configured to:
analyze, by the optical character recognition, the plurality of electronic documents to identify data in the electronic documents, wherein the at least one transaction parameter of each electronic document is determined based on the identified data of the electronic document.
